(19) United States
(12) Patent Application Publication
(10) Pub. No.: US 2024/0190380 A1
(43) Pub. Date: Jun. 13, 2024

(54) RESTRAINT SYSTEM AND SEAT BUCKLE

(71) Applicant: Gregory Lundberg, Gold Canyon, AZ (US)

(72) Inventor: Gregory Lundberg, Gold Canyon, AZ (US)

(21) Appl. No.: 18/528,428

(22) Filed: Dec. 4, 2023

Related U.S. Application Data
(60) Provisional application No. 63/386,548, filed on Dec. 8, 2022.

(51) Int. Cl. B60R 22/00

(52) U.S. Cl. CPC B60R 22/00; B60R 2022/005

(57) ABSTRACT

The disclosed restraint system for use in securing an article in a vehicle may include a tether member having a first end and a second end opposite the first end, a clasp member coupled to the first end, a buckle member coupled to the second end and configured to be receivably engaged by a seat belt buckle receptacle, and an adjustable strap assembly operable to connect two surfaces of the tether member to provide a holding tension therebetween. The adjustable strap assembly may be utilized to adjust a size of an opening of a tether loop formed by the tether member to fit the tether member around a seat belt buckle receptacle and/or seat belt webbing.

### CROSS REFERENCE TO RELATED APPLICATION

This application claims priority to U.S. Provisional patent application to Gregory Lundberg entitled “Restraint System and Seat Buckle” Ser. No. 63/386,548, filed Dec. 8, 2022, the disclosure of which is hereby incorporated entirely herein by reference.

### BACKGROUND

### State of the Art

In transporting an animal (e.g., dog or cat) within a vehicle, a restraint system may be used to secure the animal within the vehicle. A conventional restraint system typically comprises a leash or belt with a buckle at one end for connecting to a seat belt buckle receptacle and a clasp at the other end for connecting to a collar or harness worn by the animal. In this regard, a conventional restraint system may be used to safely restrain the animal while the vehicle is in motion to prevent harm that may occur upon a sudden stop or accident.

A conventional restraint system, however, is typically made in a configuration where the tension of the leash or belt is not adjustable, thereby needlessly limiting the ways that the restraint system can be used. In addition, a conventional restraint system is typically designed for animals, and thus does not allow for a variety of accessories or items, such as containers, bags, briefcases, backpacks, purses, umbrellas, etc. to be secured therewith. Furthermore, a conventional restraint system is typically constructed from one or more abrasive materials that are prone to causing abrasion, scuffing, or damage to the collar or harness of the animal and/or the interior of the vehicle, including the seat, center console, etc.

Accordingly, what is needed is a restraint system that can be used while the seat is occupied, is adjustable, and that allows for a variety of accessories and items to be secured while also giving the accessories and items a certain degree of freedom in moving within the vehicle for providing easy access thereto by a driver or passenger of the vehicle.

### SUMMARY

An embodiment includes a restraint system for securing an article in a vehicle, the restraint system comprising: a tether member having a first end and a second end opposite the first end, wherein the tether member is provided with a tether loop at the second end thereof; at least one clasp member coupled to the first end of the tether member; a buckle member coupled to the second end of the tether member, wherein the buckle member is configured to be receivably engaged by a seat belt buckle receptacle; and an adjustable strap assembly configured to connect two surfaces of the tether member to provide a holding tension therebetween, wherein the adjustable strap assembly is configured to adjust a size of an opening of the tether loop, and wherein the opening of the loop is adjustable for fitting the tether member around the seat buckle receptacle and/or seat belt webbing.

The buckle member may be adjustably coupled to the tether loop of the tether member. The two surfaces of the adjustable strap assembly may be provided with hook and loop fasteners. The at least one clasp member may comprise a clasp fastener. The clasp fastener may comprise a hook. The hook may be an S-hook. The at least one clasp member may be rotatably coupled through a fixed loop on the first end of the tether member.

An embodiment includes a method of using a restraint system for securing an article within a vehicle, the method comprising: providing a restraint system which comprises a tether member having a first end and a second end opposite the first end, wherein the tether member is provided with a tether loop at the second end thereof; at least one clasp member coupled to the first end of the tether member; a buckle member coupled to the second end of the tether member, wherein the buckle member is configured to be receivably engaged by a seat belt buckle receptacle; and an adjustable strap assembly configured to connect two surfaces of the tether member to provide a holding tension therebetween, wherein the adjustable strap assembly is configured to adjust a size of an opening of the tether loop, and wherein the opening of the tether loop is adjustable for fitting the tether member around the seat buckle receptacle and/or seat belt webbing; coupling the at least one clasp member to an article; inserting a seat belt buckle of a vehicle through the opening of the tether loop and into the seat belt buckle receptacle; and tightening the tether loop around the seat belt buckle receptacle and/or seat belt webbing.

The clasp member may be coupled to a handle, collar and/or harness of the article. The buckle member may be adjustably coupled to the tether loop of the tether member. The two surfaces of the adjustable strap assembly may be provided with hook and loop fasteners. The at least one clasp member may comprise a clasp fastener. The clasp fastener may comprise a hook. The hook may be an S-hook. The at least one clasp member may be rotatably coupled through a fixed loop on the first end of the tether member.

Another embodiment includes a method of using a restraint system for securing an article within a vehicle, the method comprising: providing a restraint system which comprises a tether member having a first end and a second end opposite the first end, wherein the tether member is provided with a tether loop at the second end thereof; at least one clasp member coupled to the first end of the tether member; a buckle member coupled to the second end of the tether member, wherein the buckle member is configured to be receivably engaged by a seat belt buckle receptacle; and an adjustable strap assembly configured to connect two surfaces of the tether member to provide a holding tension therebetween, wherein the adjustable strap assembly is configured to adjust a size of an opening of the tether loop; coupling the at least one clasp member to an article; and inserting the buckle member coupled to the second end of the tether member into the seat belt buckle receptacle.

The clasp member may be coupled to a handle, collar and/or harness of the article. The buckle member may be adjustably coupled to the tether loop of the tether member. The two surfaces of the adjustable strap assembly may be provided with hook and loop fasteners. The at least one clasp member may comprise a clasp fastener.

### BRIEF DESCRIPTION OF THE DRAWINGS

A more complete understanding of the present invention may be derived by referring to the detailed description when considered in connection with the following illustrative figures.

FIG. 1 representatively illustrates a restraint system in accordance with an embodiment of the present invention;

FIG. 2 representatively illustrates a restraint system secured to a seat belt buckle receptacle in accordance with an embodiment of the present invention;

FIG. 3 representatively illustrates a restraint system secured to a seat belt buckle receptacle in accordance with an embodiment of the present invention;

FIG. 4 representatively illustrates a restraint system secured to a seat belt webbing in accordance with an embodiment of the present invention;

FIG. 5 representatively illustrates a restraint system secured to a seat belt buckle receptacle in accordance with an embodiment of the present invention;

FIG. 6 representatively illustrates a flow chart of a method of using a restraint system in accordance with an embodiment of the present invention; and

FIG. 7 representatively illustrates a flow chart of a method of using a restraint system in accordance with an embodiment of the present invention.

### DETAILED DESCRIPTION OF EMBODIMENTS OF THE INVENTION

The subject invention may be described in terms of functional components. Such functional components may be realized by any number of components configured to perform the specified functions and achieve the various results. For example, the subject invention may employ various tethers, clasps, buckles, and the like, which may carry out a variety of functions. In addition, the present invention may be practiced in conjunction with any one of various vehicles, and the restraint system described herein is merely one exemplary application for the invention.

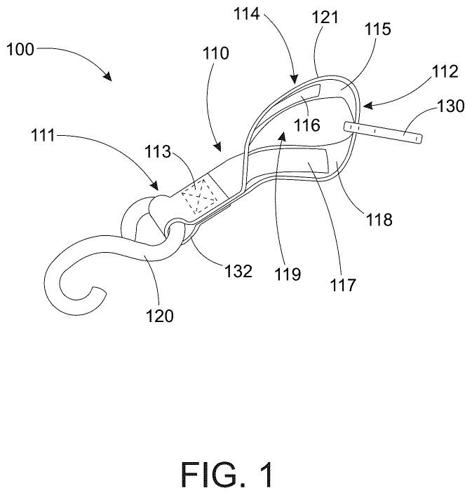

Referring to FIGS. 1-5, a restraint system 100 adapted to restrain an article 102 while a vehicle is in motion to prevent unwanted movement or spillage that may occur upon a sudden stop, turn, or accident may comprise a tether member 110, at least one clasp member 120, and a buckle member 130. As generally used herein, an “article” includes, but is not limited to, any item or object, such as an accessory, a container, bag, briefcase, backpack, purse, and the like. Furthermore, an “article” may be any animal, such as a dog, cat, and the like.

The tether member 110 may comprise a first end 111 and a second end 112 opposite the first end 111. The tether member 110 may be constructed from any suitable material or fabric, such as buckram, plastic, elastic fabric, elastane, microfibers, nylon, polypropylene, “Cuben Fiber” or “CTF3”, polyester, mesh fabric, cotton, flax, wool, or any combination of suitable material or fabrics. Additionally, the tether member 110 may comprise a thickness between about 1 inch and about 2 inches, and more preferably 1 3/16 inches, 1 5/16 inches, 1 7/16 inches, or 1 9/16 inches.

In various embodiments, the tether member 110 may be fitted with an adjustable strap assembly 114 operable to connect two surfaces of the tether member 110 to provide a holding tension therebetween, such as commonly used on adjustable ball caps. For example, in one embodiment, a first surface 115 of the tether member 110 may be fitted with a strip of hook and loop fastener 116 which may adhere firmly to a conforming strip of hook and loop fastener 117 fitted to a second surface 118 of the tether member 110. In this regard, it should be noted that the two strips of hook and loop fastener 116, 117 fitted on the tether member 110 may be fitted in any suitable location and manner to adjust a size of an opening 119 formed by a tether loop 121 of the tether member 110. The size of the opening 119 may be adjusted such that the tether member 110 may be secured tightly around a seat belt buckle receptacle 104 and/or a seat belt webbing 106. As such, the restraint system 100 may secure the article 102 in the vehicle without requiring the buckle member 130 to be receivably engaged by the seat belt buckle receptacle 104. In this regard, the restraint system 100 may be utilized even while the seat in the vehicle is occupied by a person 107 or animal (not shown).

In one embodiment, in addition to being fitted with the adjustable strap assembly 114 described above, the tether member 110 may be fitted with a first non-slip material or fabric (not shown) which may adhere firmly to a conforming second non-slip material or fabric (not shown). The first non-slip material/fabric and the second non-slip material/fabric may be fitted on the first surface 115 and/or or sewn into (or integrally formed with) the first surface 115 of the tether member 110 between the strip of hook and loop fastener 116 and the strip of hook and loop fastener 117. The first and second non-slip material/fabric may each comprise polyester, cotton, or any other suitable non-slip material that has a PVC-based non-slip layer. The finish of the first and second non-slip material/fabric may be sanded, “bumpy,” or perforated.

In some embodiments, the tether member 110 may be fitted with a length adjustor (not shown) for adjusting the length of the tether member 110. The length may be adjusted to a desired length. The length may be adjusted to allow the article adequate freedom in moving within the vehicle for providing easy access thereto. The length adjustor may have a plurality of web portions (not shown) and separated by a first opening (not shown) and a second opening (not shown). The openings may be sized to allow the tether member 110 to be inserted therethrough. The length adjustor may be moved along the tether member 110 to change the overall length of the restraint system 100 from the clasp member 120 to the buckle member 130.

In one embodiment, the clasp member 120 may be coupled to a fixed loop 132 that is formed by fixedly connecting two surfaces of the tether 110, such as shown in FIG. 1. In another embodiment, instead of coupling the clasp member 120 to the fixed loop 132, the clasp member 120 may be coupled directly to the first end 111 of the tether member 110. The clasp member 120 may also comprise a release mechanism (not shown) that allows a user to separate and remove the clasp member 120 from the first end 111 of the tether member 110. In an exemplary embodiment, the clasp member 120 may be constructed from or coated with a non-abrasive material to prevent abrasion, scuffing, or damage to a D-ring, shoulder strap, collar, or handle of the article 102. The clasp member 120 may comprise a fastener, such as a snap hook, a quick-link carabiner clip, a spring-snap carabiner clip, a spring snap, a slide bolt spring snap, a trigger snap, a hook, and more preferably an S-hook.

In one embodiment, the buckle member 130 may comprise an opening 134 through which the tether member 110 may be inserted, such that the buckle member 130 may be carried by the tether member 110. In an alternative embodiment, instead of inserting the tether member 110 through the opening 134 of the buckle member 130, the second end 112 of the tether member 110 may be coupled directly to the buckle member 130. The buckle member 130 may be receivably engaged by the seat belt buckle receptacle 104 and may therefore be sized to fit in a variety of seat belt buckle receptacles.

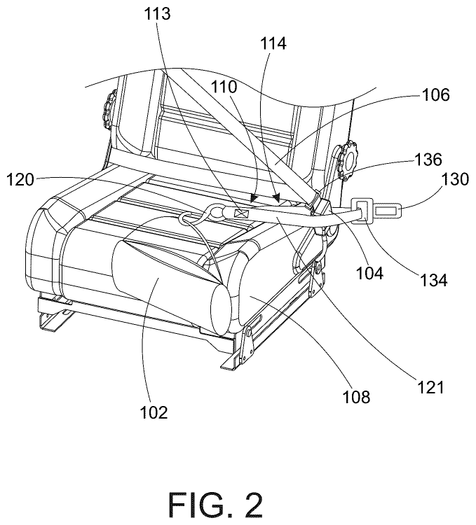

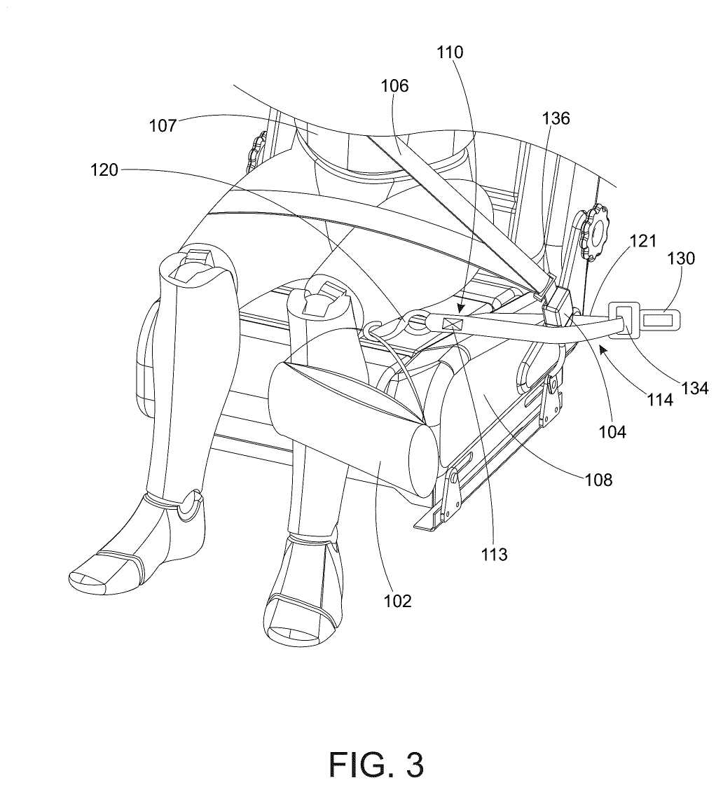

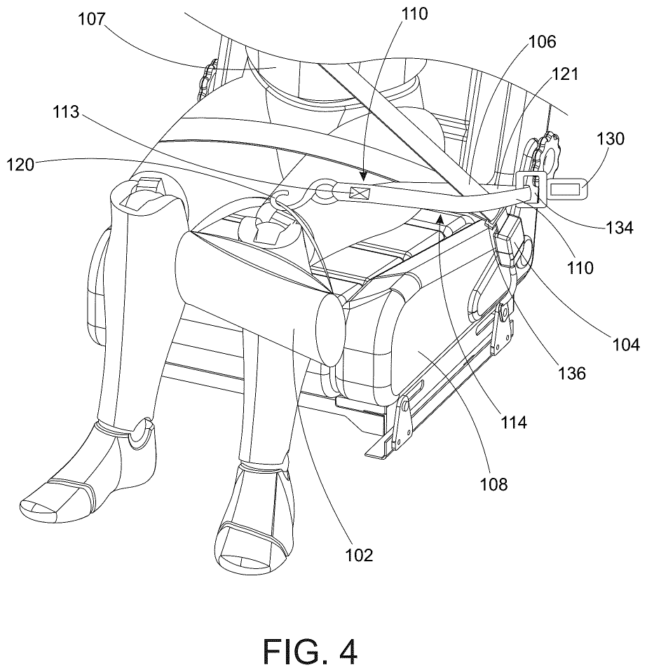

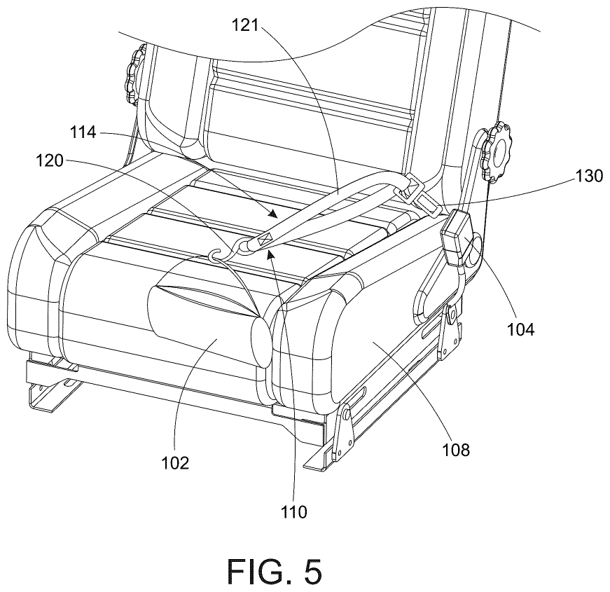

In operation, and referring now to FIGS. 1-5, utilizing the restraint system 100 to restrain the movement of the article 102 and securing it in a vehicle may comprise coupling the clasp member 120 to a handle, collar, or harness of the article 102 and inserting a seat belt buckle 136 in the vehicle through the opening 119 of the loop 121 formed by the tether member 110 and then utilizing the adjustable strap assembly 114 that is fitted to the tether member 110 to tighten the tether member 110 around the seat belt buckle receptacle 104, such as shown in FIGS. 2 and 3. In another embodiment, utilizing the restraint system 100 to restrain the movement of the article 102 may comprise securing the clasp member 120 to the article 102 and inserting the seat belt webbing 106 through the opening 119 of the loop 121 formed by the tether member 110 and utilizing the adjustable strap assembly 114 that is fitted to the tether member 110 to tighten the tether member 110 therearound, such as shown in FIG. 4. In yet another embodiment, utilizing the restraint system 100 to restrain the movement of the article 102 may comprise securing the clasp member 120 to the article 102 and inserting the buckle member 130 into the seat belt buckle receptacle 104 such that the buckle member 130 is receivably engaged by the seat belt buckle receptacle 104, as shown in FIG. 5. The article 102 may be placed on the seat or floor of the vehicle and/or in-between the seat and the center console of the vehicle. The article 102 may also be suspended over the seat, such as shown in FIGS. 2-5.

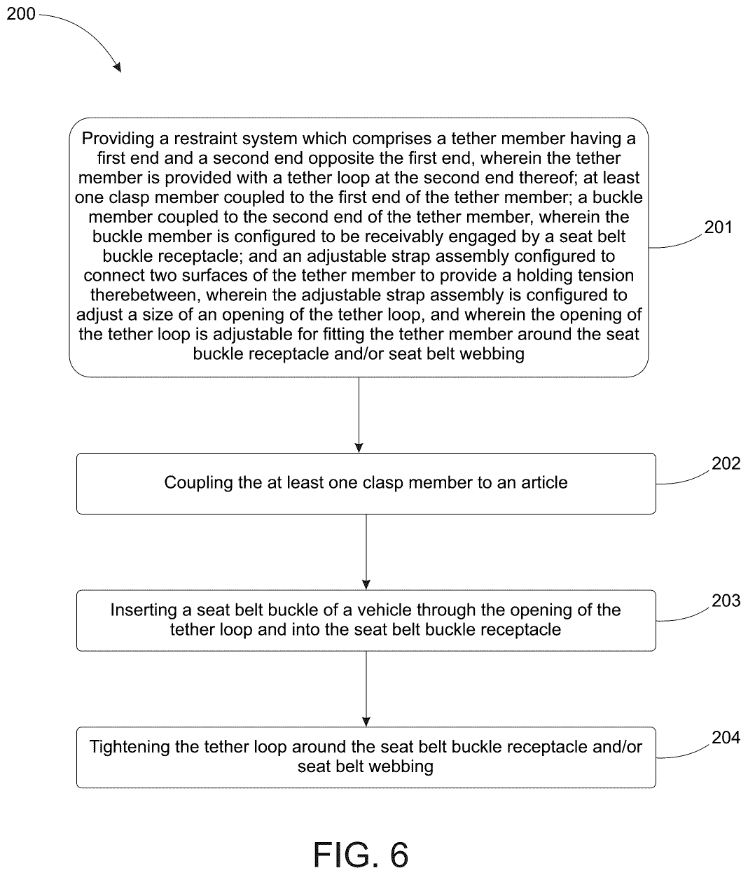

Referring to FIG. 6, an embodiment includes a method 200 of using a restraint system for securing an article within a vehicle is shown. The method 200 comprises providing a restraint system which comprises a tether member having a first end and a second end opposite the first end, wherein the tether member is provided with a tether loop at the second end thereof; at least one clasp member coupled to the first end of the tether member; a buckle member coupled to the second end of the tether member, wherein the buckle member is configured to be receivably engaged by a seat belt buckle receptacle; and an adjustable strap assembly configured to connect two surfaces of the tether member to provide a holding tension therebetween, wherein the adjustable strap assembly is configured to adjust a size of an opening of the tether loop, and wherein the opening of the tether loop is adjustable for fitting the tether member around the seat buckle receptacle and/or seat belt webbing (Step 201); coupling the at least one clasp member to an article (Step 202); inserting a seat belt buckle of a vehicle through the opening of the tether loop and into the seat belt buckle receptacle (Step 203); and tightening the tether loop around the seat belt buckle receptacle and/or seat belt webbing (Step 204).

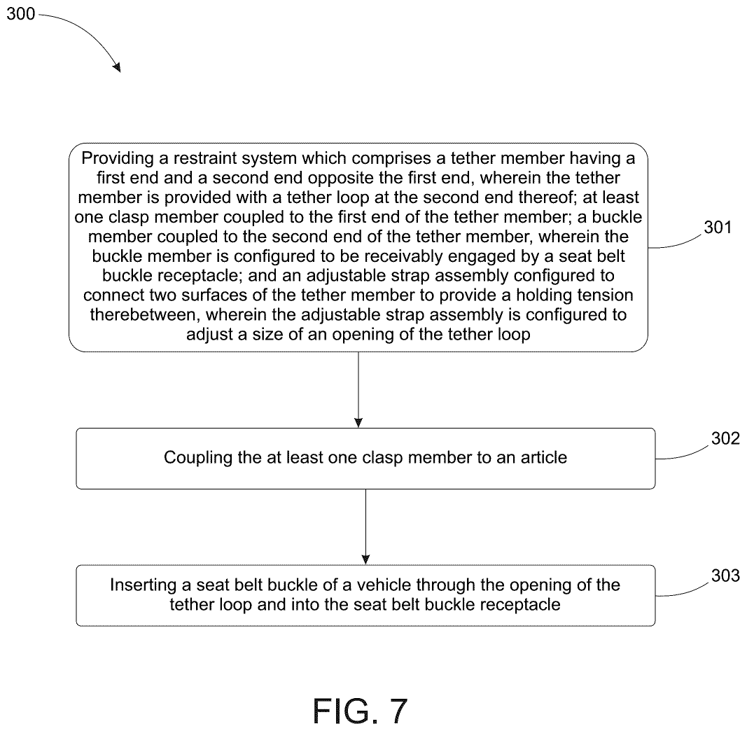

Referring to FIG. 7, an embodiment includes a method 300 of using a restraint system for securing an article within a vehicle is shown. The method 300 comprises providing a restraint system which comprises a tether member having a first end and a second end opposite the first end, wherein the tether member is provided with a tether loop at the second end thereof; at least one clasp member coupled to the first end of the tether member; a buckle member coupled to the second end of the tether member, wherein the buckle member is configured to be receivably engaged by a seat belt buckle receptacle; and an adjustable strap assembly configured to connect two surfaces of the tether member to provide a holding tension therebetween, wherein the adjustable strap assembly is configured to adjust a size of an opening of the tether loop (Step 301); coupling the at least one clasp member to an article (Step 302); and inserting the buckle member coupled to the second end of the tether member into the seat belt buckle receptacle (Step 303).

The particular implementations shown and described are illustrative of the invention and its best mode and are not intended to otherwise limit the scope of the present invention in any way. Indeed, for the sake of brevity, conventional manufacturing, connection, preparation, and other functional aspects of the apparatus may not be described in detail. Furthermore, the connections and points of contact shown in the figures are intended to represent an exemplary physical relationship between the various elements. Many alternative or additional functional relationships or physical connections may be present in a practical system.

In the foregoing description, the invention has been described with reference to specific embodiments. Various modifications and changes may be made, however, without departing from the scope of the present invention as set forth. The description and figures are to be regarded in an illustrative manner, rather than a restrictive one and all such modifications are intended to be included within the scope of the present invention. Accordingly, the scope of the invention should be determined by the generic embodiments described and their legal equivalents rather than by merely the specific examples described above. For example, the components and/or elements recited in any apparatus embodiment may be combined in a variety of permutations to produce substantially the same result as the present invention and are accordingly not limited to the specific configuration recited in the specific examples.

Benefits, other advantages, and solutions to problems have been described above with regard to particular embodiments. Any benefit, advantage, solution to problems or any element that may cause any particular benefit, advantage, or solution to occur or to become more pronounced, however, is not to be construed as a critical, required, or essential feature or component.

The terms “comprises,” “comprising,” or any variation thereof, are intended to reference a non-exclusive inclusion, such that a process, method, article, composition, or apparatus that comprises a list of elements does not include only those elements recited but may also include other elements not expressly listed or inherent to such process, method, article, composition, or apparatus. Other combinations and/or modifications of the above-described structures, arrangements, applications, proportions, elements, materials, or components used in the practice of the present invention, in addition to those not specifically recited, may be varied, or otherwise particularly adapted to specific environments, manufacturing specifications, design parameters or other operating requirements without departing from the general principles of the same.

The present invention has been described above with reference to an embodiment. However, changes and modifications may be made to the embodiment without departing from the scope of the present invention. These and other changes or modifications are intended to be included within the scope of the present invention.

1. A restraint system for securing an article in a vehicle, the restraint system comprising:
a tether member having a first end and a second end opposite the first end, wherein the tether member is provided with a tether loop at the second end thereof,
at least one clasp member coupled to the first end of the tether member;
a buckle member coupled to the second end of the tether member, wherein the buckle member is configured to be receivably engaged by a seat belt buckle receptacle; and
an adjustable strap assembly configured to connect two surfaces of the tether member to provide a holding tension therebetween, wherein the adjustable strap assembly is configured to adjust a size of an opening of the tether loop, and wherein the opening of the tether loop is adjustable for fitting the tether member around the seat buckle receptacle and/or seat belt webbing.

2. The restrain system according to claim 1, wherein the buckle member is adjustably coupled to the tether loop of the tether member.

3. The restrain system according to claim 1, wherein the two surfaces of the adjustable strap assembly are provided with hook and loop fasteners.

4. The restrain system according to claim 1, wherein the at least one clasp member comprises a clasp fastener.

5. The restrain system according to claim 4, wherein the clasp fastener comprises a hook.

6. The restraint system of claim 5, wherein the hook is an S-hook.

7. The restrain system according to claim 1, wherein the at least one clasp member is rotatably coupled through a fixed loop on the first end of the tether member.

8. A method of using a restraint system for securing an article within a vehicle, the method comprising:
providing a restraint system which comprises a tether member having a first end and a second end opposite the first end, wherein the tether member is provided with a tether loop at the second end thereof,
at least one clasp member coupled to the first end of the tether member;
a buckle member coupled to the second end of the tether member, wherein the buckle member is configured to be receivably engaged by a seat belt buckle receptacle; and
an adjustable strap assembly configured to connect two surfaces of the tether member to provide a holding tension therebetween, wherein the adjustable strap assembly is configured to adjust a size of an opening of the tether loop, and wherein the opening of the tether loop is adjustable for fitting the tether member around the seat buckle receptacle and/or seat belt webbing;
coupling the at least one clasp member to an article;
inserting a seat belt buckle of a vehicle through the opening of the tether loop and into the seat belt buckle receptacle; and
tightening the tether loop around the seat belt buckle receptacle and/or seat belt webbing.

9. The method according to claim 8, wherein the at least one clasp member is coupled to a handle, collar and/or harness of the article.

10. The according to claim 8, wherein the buckle member is adjustably coupled to the tether loop of the tether member.

11. The method according to claim 8, wherein the two surfaces of the adjustable strap assembly are provided with hook and loop fasteners.

12. The method according to claim 8, wherein the at least one clasp member comprises a clasp fastener.

13. The method according to claim 12, wherein the clasp fastener comprises a hook.

14. The method according to claim 13, wherein the hook is an S-hook.

15. The method according to claim 8, wherein the at least one clasp member is rotatably coupled through a fixed loop on the first end of the tether member.

16. A method of using a restraint system for securing an article within a vehicle, the method comprising:
providing a restraint system which comprises a tether member having a first end and a second end opposite the first end, wherein the tether member is provided with a tether loop at the second end thereof,
at least one clasp member coupled to the first end of the tether member;
a buckle member coupled to the second end of the tether member, wherein the buckle member is configured to be receivably engaged by a seat belt buckle receptacle; and
an adjustable strap assembly configured to connect two surfaces of the tether member to provide a holding tension therebetween, wherein the adjustable strap assembly is configured to adjust a size of an opening of the tether loop;
coupling the at least one clasp member to an article; and
inserting the buckle member coupled to the second end of the tether member into the seat belt buckle receptacle.

17. The method according to claim 16, wherein the at least one clasp member is coupled to a handle, collar and/or harness of the article.

18. The according to claim 16, wherein the buckle member is adjustably coupled to the tether loop of the tether member.

19. The method according to claim 16, wherein the two surfaces of the adjustable strap assembly are provided with hook and loop fasteners.

20. The method according to claim 16, wherein the at least one clasp member comprises a clasp fastener.
